(19) United States
(12) Patent Application Publication
(10) Pub. No.: US 2018/0076571 A1
(43) Pub. Date: Mar. 15, 2018

(54) BLOCK-OUT DEVICE FOR COMPUTER JACK MODULES

(71) Applicant: YOU HUNG INTERNATIONAL CO., LTD., New Taipei City (TW)

(72) Inventor: TZU-RUNG TSAY, NEW TAIPEI CITY (TW)

(21) Appl. No.: 15/814,585

(22) Filed: Nov. 16, 2017

Related U.S. Application Data
(63) Continuation-in-part of application No. 15/370,323, filed on Dec. 6, 2016.

(30) Foreign Application Priority Data
Jan. 26, 2016 (TW) 105201177

(51) Int. Cl. H01R 13/639; H01R 24/64

(52) U.S. Cl. CPC H01R 13/6397; H01R 2107/00; H01R 2201/04; H01R 24/64

(57) ABSTRACT

A block-out device includes a locker and a key. The locker has a hollow housing in a shape corresponding to a socket of a cable port for engagement, a locker hole at a front surface thereof and a latch body connecting to a rear surface of the housing. The latch body has a rear section extended upwards toward a front surface of the housing and then downwards to form a displaceable piece parallel with the front surface of the housing with a holding section at a top of the displaceable piece and a block facing toward an inner end of the locker hole. The key has its front section arranged correspondingly to a shape of the locker hole to be inserted therein and rotated for unlocking. An eccentric block is further arranged at the front section of the key correspondingly to the block on the displaceable piece for removing the locker from the socket of the cable port in operation.

This patent application is a continuation-in-part of Ser. No. 15/370,323 filed on Dec. 6, 2016, currently pending.

### BACKGROUND OF THE INVENTION

### 1. Field of the Invention

The present invention relates to a block-out device, particularly to one that unlocks a locker from a cable port by a key.

### 2. Description of the Related Art

Nowadays internet networks have been widely applied in information transfer. Such networks mainly rely on the Ethernet networks for rapid and stable transfer, which is suitable in many industries such as the government, the police, the military, and business companies; however, such technology also allows unauthorized users to have access to the information and data easily, leaving uncertainties in information security.

There are various locks designed for such problem in the markets. For example, a block-out cover and a removal tool are disclosed in U.S. Pat. No. 8,202,110. The device covers jack modules to prevent from undesirable accessibility, and further has a tool to remove the cover from the jack modules. The removal tool is a tweezer that engages the cover and removes it by clamping and pulling. Such operation could damage the device with improper pulling angle and pulling forces; also, the operation will be unsmooth once a minor damage is done.

### SUMMARY OF THE INVENTION

A primary objective of the present invention is to provide a block-out device that ensures more safety in accessibility to data via the internet networks by having a cable port locked by a locker and unlocked by a key smoothly.

To achieve the objective, the present invention mainly comprises a locker and a key.

The locker comprises a hollow housing arranged in a shape corresponding to a socket of a cable port for engagement and including a front surface, a rear surface and two corresponding lateral surfaces, wherein a locker hole is arranged at the front surface of the housing, said locker hole penetrating through the front surface and having a blocking element arranged in a semicircular shape therein to form a semicircular through hole within the locker hole; a latch body having a rear section linking to a top of the rear surface of the housing, extending slightly upwards toward the front surface of the housing to form an inclined surface and then downwards from a top point of the inclined surface to form a displaceable piece parallel with the front surface of the housing and leaving a gap in-between the inclined surface and the front surface, said top point being lower than a top of the front surface, said displaceable piece forming a holding section at an acute angle from a top thereof to the top point of the inclined surface and having a free end with a block at a bottom thereof facing toward the front surface of the housing corresponding to the locker hole.

The key has a front section arranged in a shape corresponding to a shape of the locker hole for engagement, said front section including an engaging section for engaging in the locker hole and rotating in the through hole and an eccentric block arranged at a front end of the front section corresponding to the block of the displaceable piece for passing through the through hole to the gap and located above the block for operation.

Whereby when the locker is engaged in the socket of the cable port, the holding section abuts on a pair of symmetrical staircase edges at an upper part of the cable port and locks up the socket of the cable port; then when the key is inserted into the locker hole and rotated, the eccentric block presses the block of the displaceable piece downwards to displace the displaceable piece downwards and release the abutting status of the holding section from the staircase edges of the cable port, so as to unlock the cable port for use.

Furthermore, the key further has a protrusion at a side thereof for recognition when it is inserted into the locker hole. The locker hole further has a positioning space arranged along a quarter of an inner periphery of the locker hole and the key further has a positioning ridge on an outer periphery of the front section corresponding to the positioning space in the locker hole, thereby the positioning ridge is rotated within the positioning space when the key is rotated for unlocking.

With structures disclosed above, the present invention has the eccentric block to remove the locker together with the key from a cable port for which to be accessible for information and data via the internet connection. Therefore, the device is easier operated and has less possibility of damages than a conventional lock unlocked by a tweezer.

### BRIEF DESCRIPTION OF THE DRAWINGS

FIG. 1A is an exploded view of the present invention in a preferred embodiment;

FIG. 1B is a sectional view of the present invention in a preferred embodiment without engagement of elements thereof;

FIG. 1C is a partially enlarged view of a locker and a key according to the present invention in a preferred embodiment;

FIG. 1D is a front elevation view of the locker according to the present invention in a preferred embodiment;

FIG. 1E is a partially exploded view of FIG. 1A;

FIG. 2A is a perspective view of the present invention in a preferred embodiment;

FIG. 2B is a sectional view of the present invention in a preferred embodiment with a locker thereof locking up a socket of a cable port;

FIG. 2C is a partially exploded view of FIG. 2A;

FIG. 3A is a perspective view of the present invention in a preferred embodiment, showing the locker locking up the cable port;

FIG. 3B is a sectional view of the present invention in a preferred embodiment, showing the locker locking up the cable port;

FIG. 3C is a partially exploded view of FIG. 3A;

FIG. 4A is a perspective view of the present invention in a preferred embodiment, showing the locker being pulled by the key from the cable port for unlocking;

FIG. 4B is a sectional view of the present invention in a preferred embodiment, showing the locker unlocking the cable port; and

FIG. 4C is a sectional view in partial of the present invention in a preferred embodiment, illustrating the locker being pulled by the key from the cable port for unlocking.

### DETAILED DESCRIPTION OF THE PREFERRED EMBODIMENT

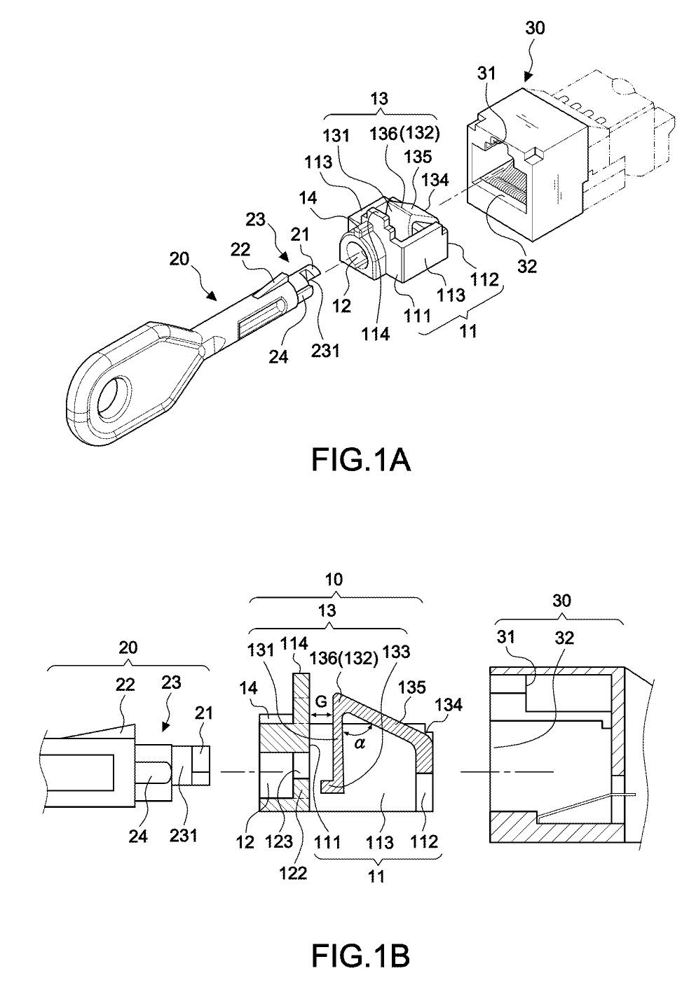

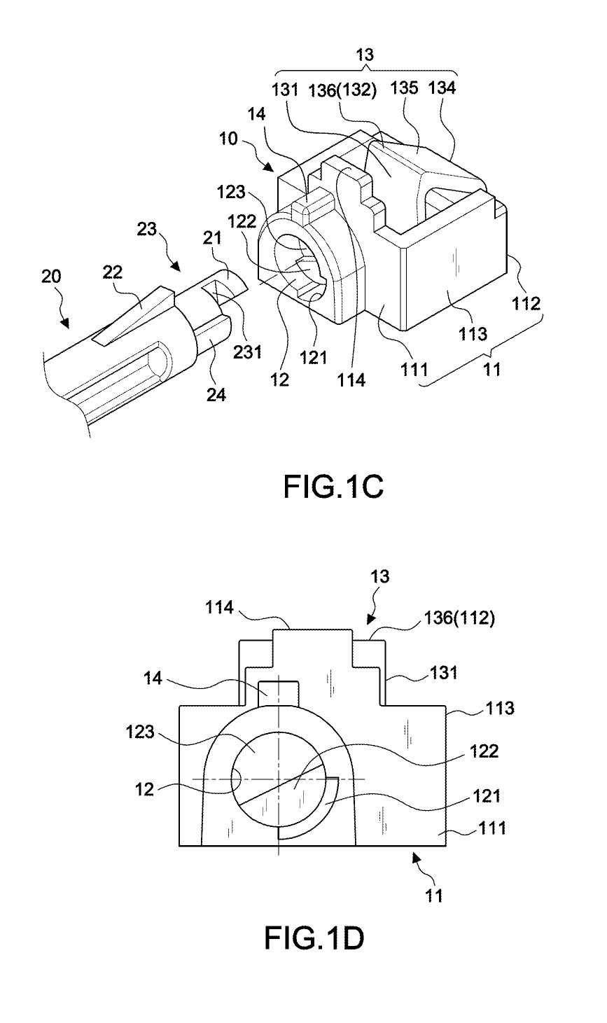

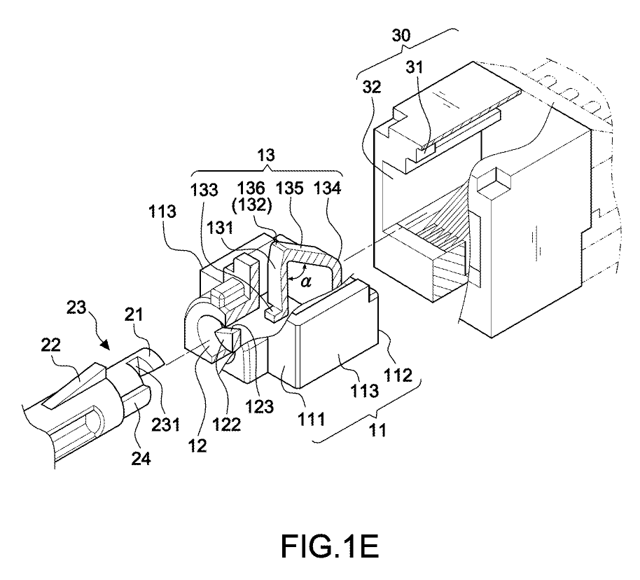

With reference to FIGS. 1A-4C, in a preferred embodiment, a block-out device for computer jack modules mainly comprises a locker 10 and a key 20 for the locker 10.

The locker 10 includes a hollow housing 11, a locker hole 12 and a latch body 13. The housing 11 is arranged in a shape corresponding to a socket 32 of a cable port 30 for engagement and further includes a front surface 111, a rear surface 112 and two corresponding lateral surfaces 113.

The locker hole 12 is arranged at the front surface 111 of the housing 111, penetrating through the front surface 111 and further including a blocking element 122 arranged in a semicircular shape therein to form a semicircular through hole 123 within the locker hole 12 as shown in FIGS. 1B, 1D and 1E.

The latch body 13 has a rear section 134 linking to a top of the rear surface 112 of the housing 11, extending slightly upwards toward the front surface 111 of the housing 11 to form an inclined surface 135 and then downwards from a top point 136 of the inclined surface 135 to form a displaceable piece 131 parallel with the front surface 111 of the housing 11 and leaving a gap G in-between the inclined surface 135 and the front surface 111 as shown in FIG. 1B. The top point 136 of the inclined surface 135 is arranged lower than a top 114 of the front surface 111. The displaceable piece 131 is arranged closer to the front surface 111 of the housing than to the rear surface 112 and further forms a holding section 132 at an acute angle α from a top thereof to the top point 136 of the inclined surface 135 as shown in FIGS. 1A and 1B. A free end with a block 133 is arranged at a bottom of the displaceable piece 131, facing toward the front surface 111 of the housing 11 correspondingly to the locker hole 12.

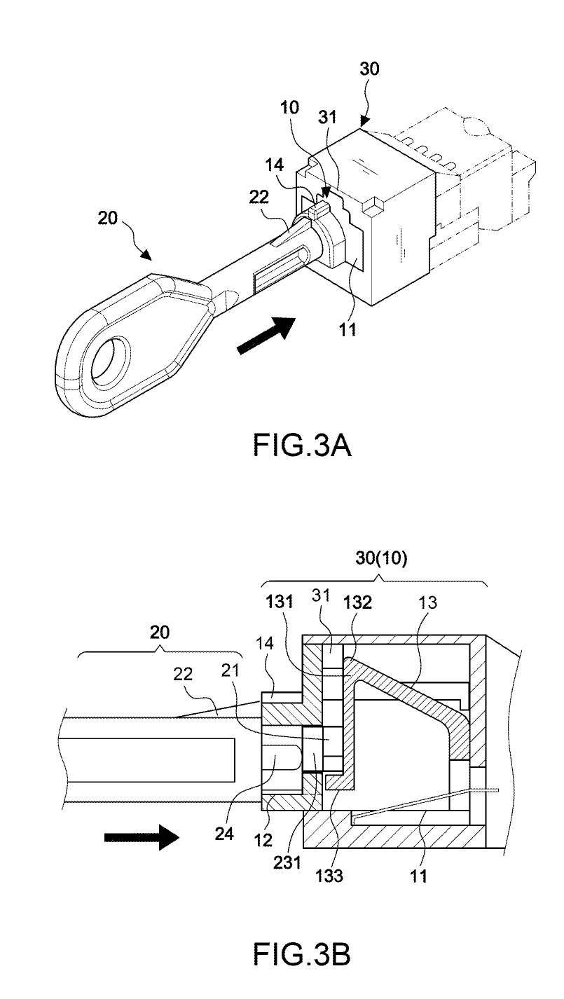

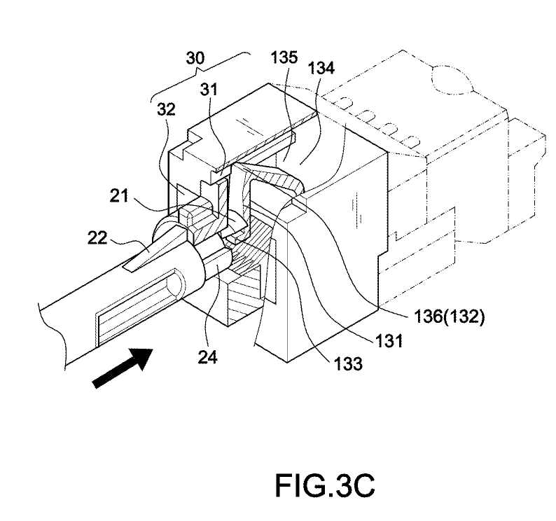

The key 20 has a front section 23 arranged in a shape corresponding to a shape of the locker hole 12 for engagement, and the front section 23 includes an engaging section 231 for engaging in the locker hole 12 and rotating in the through hole 123 and an eccentric block 21 arranged at a front end of the front section 23 corresponding to the block 133 of the displaceable piece 131 for passing through the through hole 123 to the gap G and located above the block 133 for operation as shown in FIGS. 3B and 3C.

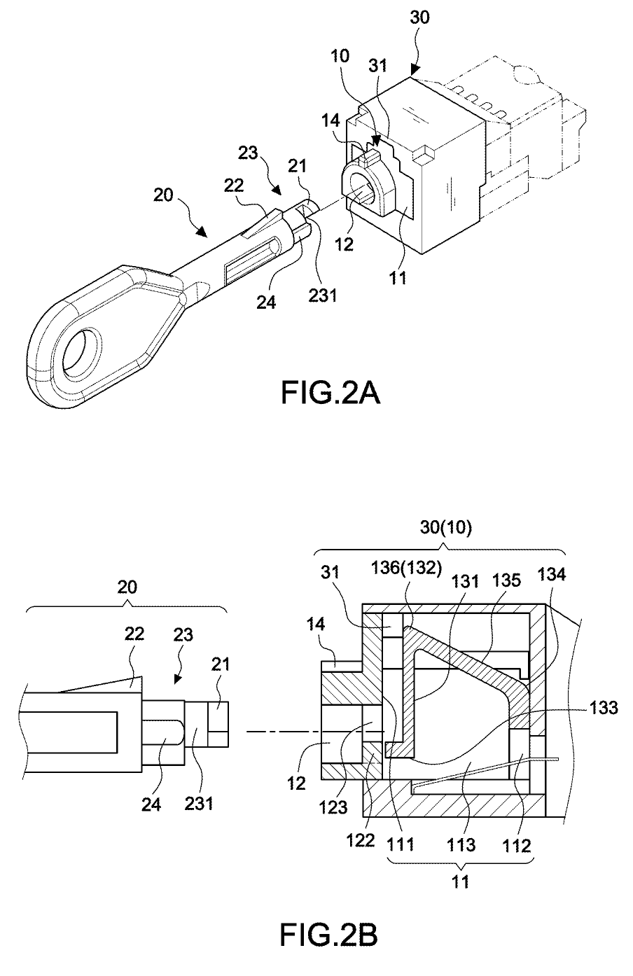

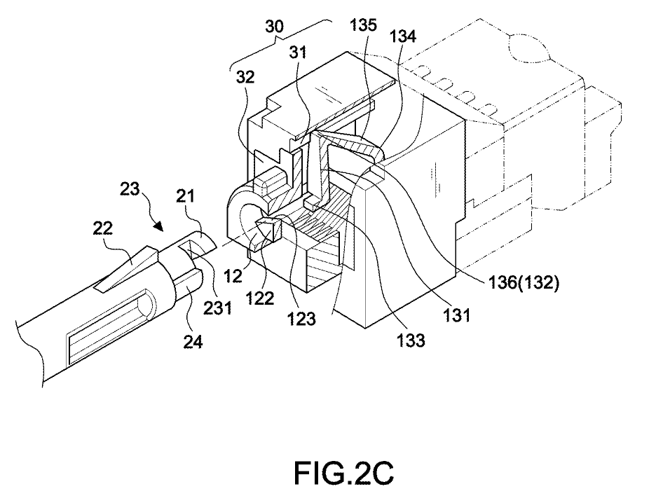

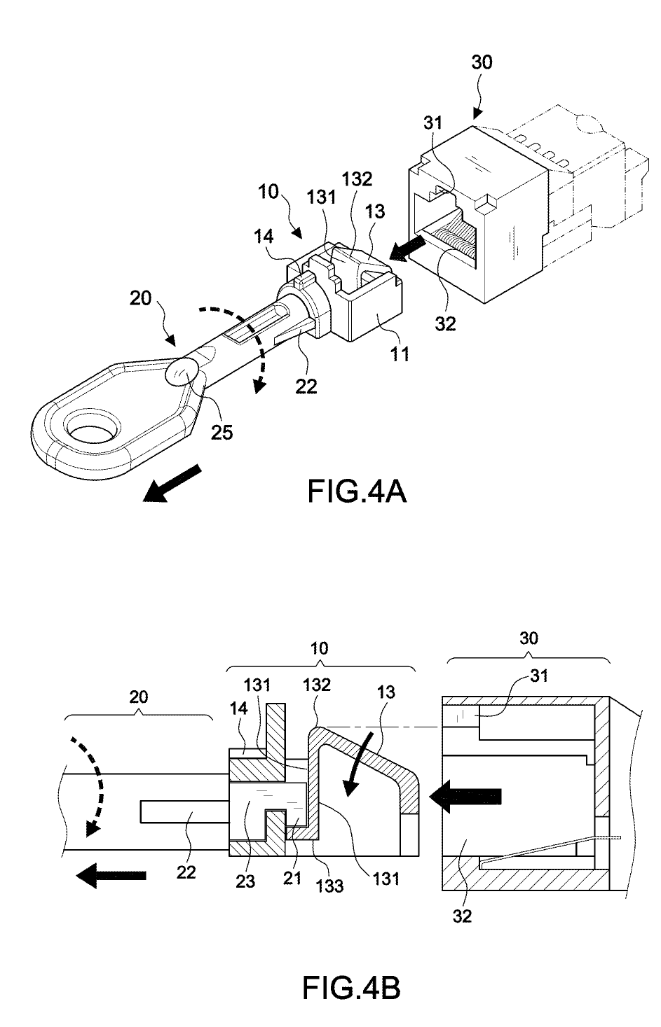

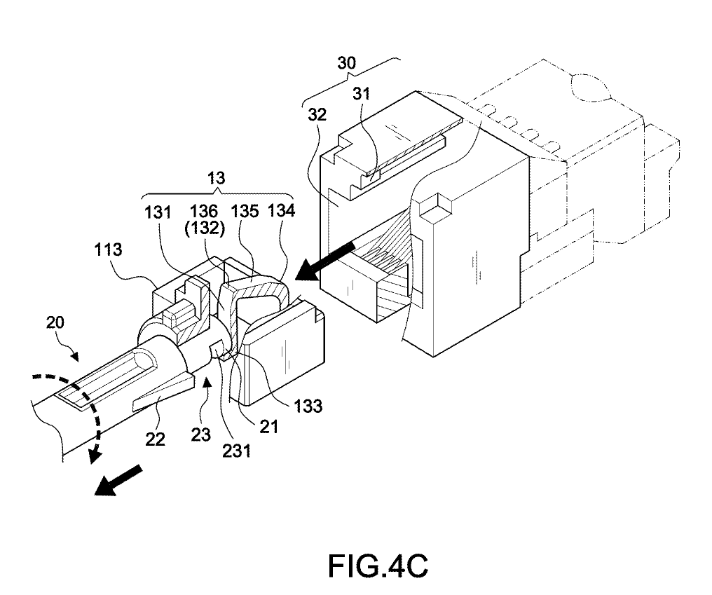

Further referring to FIGS. 2A-2C, when the locker 10 is engaged in the socket 32 of the cable port 30, the holding section 132 abuts on a staircase edge 31 of the cable port 30 and locks up the socket 32 of the cable port 30; the staircase edge 31 are arranged in a symmetrical pair at an upper part of the cable port 30 as shown in FIGS. 3A and 3B. Then when the key 20 is inserted into the locker hole 12 and rotated, the eccentric block 21 presses the block 133 of the displaceable piece 131 downwards to displace the displaceable piece 131 downwards and release the abutting status of the holding section 132 from the staircase edges 31 of the cable port 30, so as to pull out the locker 10 together with the key 20 and unlock the cable port 30 for use as shown in FIGS. 4A and 4B.

In addition, the key 20 has an aligning section 22 at a middle section thereof corresponding to a reference portion 14 arranged on the housing 11 above the locker hole 12, so that the aligning section 22 is aligned with the reference portion 14 when inserting the key 20 to unlock the device.

Also, the key 20 has a protrusion 25 at a side thereof for recognition so that a user can perform unlocking simply by recognizing a position of the protrusion 25 without looking to confirm if the key 20 is inserted properly. In this embodiment, the protrusion 25 can be a solid block or linear protrusion. As illustrated in FIGS. 1C and 1D, the locker hole 12 further has a positioning space 121 arranged along a quarter of an inner periphery of the locker hole 12 and the key 20 further has a positioning ridge 24 on an outer periphery of the front section 23 corresponding to the positioning space 121 in the locker hole 12, thereby the positioning ridge 24 is rotated within the positioning space 121 when the key 20 is rotated for unlocking the locker 10. In other words, the rotation of the key 20 can be controlled precisely since the rotation of the positioning ridge 24 is limited by the positioning space 121, and the downward displacement of the block 133 by the eccentric block 21 is therefore controlled with precision as well.

In short, the block-out device has the eccentric block 21 to remove the locker 10 together with the key 20 to unlock the cable port 30, which is comparatively safer and easier than a conventional device that has a tweezer as a removal tool to take out a locker device. More importantly, with such structures, the device is able to avoid damages that can be caused by conventional devices.

What is claimed is:

1. A block-out device for computer jack modules including a locker and a key, said locker comprising:
a hollow housing arranged in a shape corresponding to a socket of a cable port for engagement and including a front surface, a rear surface and two corresponding lateral surfaces,
wherein a locker hole is arranged at the front surface of the housing, said locker hole penetrating through the front surface and having a blocking element arranged in a semicircular shape therein to form a semicircular through hole within the locker hole;
a latch body having a rear section linking to a top of the rear surface of the housing, extending slightly upwards toward the front surface of the housing to form an inclined surface and then downwards from a top point of the inclined surface to form a displaceable piece parallel with the front surface of the housing and leaving a gap in-between the inclined surface and the front surface, said top point being lower than a top of the front surface, said displaceable piece forming a holding section at an acute angle from a top thereof to the top point of the inclined surface and having a free end with a block at a bottom thereof facing toward the front surface of the housing corresponding to the locker hole; and
said key having a front section arranged in a shape corresponding to a shape of the locker hole for engagement, said front section including an engaging section for engaging in the locker hole and rotating in the through hole and an eccentric block arranged at a front end of the front section corresponding to the block of the displaceable piece for passing through the through hole to the gap and located above the block for operation;
whereby when the locker is engaged in the socket of the cable port, the holding section abuts on a pair of symmetrical staircase edges at an upper part of the cable port and locks up the socket of the cable port; then when the key is inserted into the locker hole and rotated, the eccentric block presses the block of the displaceable piece downwards to displace the displaceable piece downwards and release the abutting status of the holding section from the staircase edges of the cable port, so as to unlock the cable port for use.

2. The block-out device for computer jack modules as claimed in claim 1, wherein the key has an aligning section at a middle section thereof corresponding to a reference portion arranged on the housing above the locker hole, so that the aligning section is aligned with the reference portion when inserting the key to unlock the device.

3. The block-out device for computer jack modules as claimed in claim 1, wherein the key further has a protrusion at a side thereof for recognition when it is inserted into the locker hole.

4. The block-out device for computer jack modules as claimed in claim 1, wherein the locker hole further has a positioning space arranged along a quarter of an inner periphery of the locker hole and the key further has a positioning ridge on an outer periphery of the front section corresponding to the positioning space in the locker hole, thereby the positioning ridge is rotated within the positioning space when the key is rotated for unlocking.
